(19) United States
(12) Patent Application Publication
(10) Pub. No.: US 2026/0265429 A1
(43) Pub. Date: Sep. 10, 2026

(54) POLYOLEFIN COMPOSITIONS FOR ROTOMOLDING

(71) Applicant: Dow Global Technologies LLC, Midland, MI (US)

(72) Inventors: Xiaosong Wu, Sugar Land, TX (US); Glendimar Molero, Clute, TX (US); Rhett A. Baillie, Missouri City, TX (US); Steve H. Ma, Sugarland, TX (US)

(21) Appl. No.: 18/875,502

(22) PCT Filed: Aug. 4, 2023
(86) PCT No.: PCT/US2023/029514

§ 371 Date: Dec. 16, 2024

Related U.S. Application Data
(60) Provisional application No. 63/395,376, filed on Aug. 5, 2022.
(60) Provisional application No. 63/395,369, filed on Aug. 5, 2022.

(51) Int. Cl. C08F 210/02; C08F 2/01; C08F 4/659; C08F 4/6592

(52) U.S. Cl. CPC C08F 210/02; C08F 2/01; C08F 4/65912; C08F 4/65916; C08F 4/65925; C08F 2420/02

(57) ABSTRACT

Embodiments of the present disclosure are directed towards rotomolding compositions made with asymmetrical hafnium metallocenes having an n-propyl cyclopentadienyl ligand, processes utilizing the rotomolding compositions, and products made with the compositions.

### FIELD OF DISCLOSURE

Embodiments of the present disclosure are directed towards polyolefin compositions useful for rotomolding.

### BACKGROUND

The use of polyolefin compositions in the formation of molded articles is generally known. Any conventional method may be employed to produce such polyolefin compositions. Various polymerization techniques using different catalyst systems have been employed to produce such polyolefin compositions suitable for the formation of articles.

### SUMMARY

The present disclosure provides various embodiments, including, without limitation, the following. a polyolefin composition, wherein the polyolefin composition has: a density from 0.925 to 0.960 g/cm³; a melt index (I₂) from 1.0 to 10.0 dg/min; a Mn of 17,000 to 40,000; a Mw of 50,000 to 120,000; a Mz of 120,000 to 300,000; a molecular weight distribution (Mw/Mn) from 2.0 to 3.5; and a molecular weight comonomer distribution index vs density relationship such that: molecular weight comonomer distribution index>−161.2*Density+152.5.

### BRIEF DESCRIPTION OF DRAWINGS

FIG. 1 is a data plot of secant modulus at 1% vs density according to an embodiment of the present disclosure.

FIG. 2 is a data plot of molecular weight comonomer distribution index (MWCDI) vs density according to an embodiment of the present disclosure.

FIG. 3 is a data plot of molecular weight comonomer distribution index (MWCDI) vs density according to an embodiment of the present disclosure.

### DETAILED DESCRIPTION

Rotomolding is a high-temperature, zero-shear process that can be used to make articles. Down gauging to produce light-weight products, while maintaining processability and performance is desirable for rotomolding. Higher density polymers, e.g., polyolefins, can help provide product downgauging; however, for single reactor unimodal polymers this increase in density can result in an undesirable decrease in impact strength and/or environmental stress cracking resistance (ESCR).

Rotomolding compositions and rotomolding methods are discussed herein. Advantageously, the present disclosure provides a unimodal composition with higher modulus, greater impact strength, and good ESCR and processability, as compared to other rotomolding compositions. The unimodal composition with higher modulus and good toughness and processability can enable downgauging of rotomolded products.

The rotomolding compositions, e.g., catalyst compositions discussed herein, are made with asymmetrical hafnium metallocenes having an n-propyl cyclopentadienyl ligand. These rotomolding compositions can be utilized to make polyolefin composition having a number of desirable properties, such as having a reverse comonomer distribution (defined when the MWCDI>0) and/or an improved, i.e., greater, molecular weight comonomer distribution index (MWCDI) as compared to other polyolefin compositions, made from other metallocenes. Further these rotomolding compositions can be utilized to make polyolefin composition having desirable ESCR F₅₀ for rotomolding. Further these rotomolding compositions can be utilized to make polyolefin compositions having an improved i.e., lower, zero-shear viscosity as compared to other polyolefin compositions having a similar density that are made from other metallocenes.

The asymmetrical hafnium metallocenes having an n-propyl cyclopentadienyl ligand can be represented by structure (I):

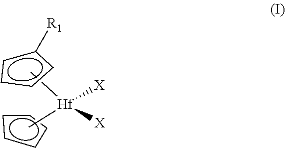

wherein: R¹ is n-propyl, and each X is independently a leaving group. As shown in structure (I), the upper cyclopentadienyl ring is substituted with the R¹ group, and the lower cyclopentadienyl ring is unsubstituted. As one cyclopentadienyl ring is substituted with the R¹ group and the other cyclopentadienyl ring is unsubstituted, in other words the two cyclopentadienyl ring ligands are different, the metallocenes can be referred to as asymmetrical hafnium metallocenes.

Embodiments of the present disclosure provide that X is a leaving group. One or more embodiments provide that X is selected from alkyls, aryls, hydridos, and halogens. One or more embodiments provide that X is selected from a halogen, (C₁ -C₅)alkyl, CH₂SiMe₃, and benzyl. One or more embodiments provide that X is selected from alkyls and halogens. One or more embodiments provide that X is Cl. One or more embodiments provide that X is methyl.

Examples of X include halogen ions, hydrides, (C₁ to C₁₂)alkyls, (C₂ to C₁₂)alkenyls, (C₆ to C₁₂) aryls, (C₇ to C₂₀)alkylaryls, (C₁ to C₁₂)alkoxys, (C₆ to C₁₆) aryloxys, (C₇ to C₈)alkylaryloxys, (C₁ to C₁₂) fluoroalkyls, (C₆ to C₁₂) fluoroaryls, and (C₁ to C₁₂) heteroatom-containing hydrocarbons and substituted derivatives thereof; one or more embodiments include hydrides, halogen ions, (C₁ to C₆)alkyls, (C₂ to C₆)alkenyls, (C₇ to C₁₈)alkylaryls, (C₁ to C₆)alkoxys, (C₆ to C₁₄) aryloxys, (C₇ to C₁₆)alkylaryloxys, (C₁ to C₆)alkylcarboxylates, (C₁ to C₆) fluorinated alkylcarboxylates, (C₆ to C₁₂) arylcarboxylates, (C₇ to C₁₈)alkylarylcarboxylates, (C₁ to C₆) fluoroalkyls, (C₂ to C₆) fluoroalkenyls, and (C₇ to C₁₈) fluoroalkylaryls; one or more embodiments include hydride, chloride, fluoride, methyl, phenyl, phenoxy, benzoxy, tosyl, fluoromethyls and fluorophenyls; one or more embodiments include (C₁ to C₁₂)alkyls, (C₂ to C₁₂)alkenyls, (C₆ to C₁₂) aryls, (C₇ to C₂₀)alkylaryls, substituted (C₁ to C₁₂)alkyls, substituted (C₆ to C₁₂) aryls, substituted (C₇ to C₂₀)alkylaryls, and (C₁ to C₁₂) heteroatom-containing alkyls, (C₁ to C₁₂) heteroatom-containing aryls, and (C₁ to C₁₂) heteroatom-containing alkylaryls; one or more embodiments include chloride, fluoride, (C₁ to C₆)alkyls, (C₂ to C₆)alkenyls, (C₇ to C₁₈)alkylaryls, halogenated (C₁ to C₆)alkyls, halogenated (C₂ to C₆)alkenyls, and halogenated (C₇ to C₁₈)alkylaryls; one or more embodiments include fluoride, methyl, ethyl, propyl, phenyl, methylphenyl, dimethylphenyl, trimethylphenyl, fluoromethyls (mono-, di- and trifluoromethyls) and fluorophenyls (mono-, di-, tri-, tetra- and pentafluorophenyls).

Other non-limiting examples of X groups include amines, phosphines, ethers, carboxylates, dienes, hydrocarbon radicals having from 1 to 20 carbon atoms, fluorinated hydrocarbon radicals, e.g., —C₆F₅ (pentafluorophenyl), fluorinated alkylcarboxylates, e.g., CF₃C(O)O—, hydrides, halogen ions and combinations thereof. Other examples of X ligands include alkyl groups such as cyclobutyl, cyclohexyl, methyl, heptyl, tolyl, trifluoromethyl, tetramethylene, pentamethylene, methylidene, methyoxy, ethyoxy, propoxy, phenoxy, bis(N-methylanilide), dimethylamide, and dimethylphosphide radicals, among others. In one embodiment, two or more X's form a part of a fused ring or ring system. In one or more embodiments, X can be a leaving group selected from the group consisting of chloride ions, bromide ions, (C₁ to C₁₀)alkyls, (C₂ to C₁₂)alkenyls, carboxylates, acetylacetonates, and alkoxides. In one or more embodiments, X is methyl.

The asymmetrical hafnium metallocenes having an n-propyl cyclopentadienyl ligand discussed herein can be made by contacting a hafnium complex with an alkali metal complex to make the asymmetrical hafnium metallocenes having an n-propyl cyclopentadienyl ligand. The asymmetrical hafnium metallocenes having an n-propyl cyclopentadienyl ligand discussed herein can be made by processes, e.g., with conventional solvents, reaction conditions, reaction times, and isolation procedures, utilized for making known metallocenes.

The alkali metal complex can be represented by one of the following structures:

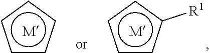

wherein M′ is lithium, sodium, or potassium and R¹ is n-propyl.

One or more embodiments provide that the hafnium complex can be represented by one the following structures:

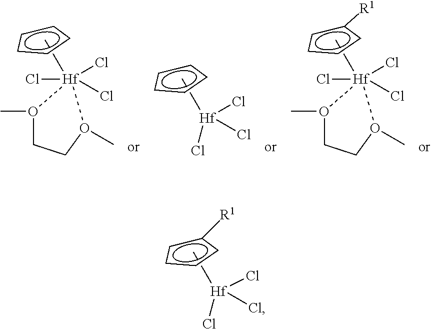

wherein R¹ is n-propyl.

One or more embodiments provide that making the asymmetrical hafnium metallocenes having an n-propyl cyclopentadienyl ligand, e.g., where each X is CI, comprises contacting the a asymmetrical hafnium metallocenes having an n-propyl cyclopentadienyl ligand with two mole equivalents of an organomagnesium halide of formula RMg (halide) or one mole equivalent of R²Mg, wherein R is (C₁-C₅)alkyl, CH₂SiMe₃, or benzyl; and the halide is CI or Br, to make the asymmetrical hafnium metallocenes having an n-propyl cyclopentadienyl ligand of structure (I) wherein each X is a halogen, a (C₁-C₅)alkyl, CH₂SiMe₃, or benzyl. One or more embodiments provide X is a (C₁-C₅)alkyl, CH₂SiMe₃, or benzyl. As used herein, all reference to the Periodic Table of the Elements and groups thereof is to the NEW NOTATION published in HAWLEY'S CONDENSED CHEMICAL DICTIONARY, Thirteenth Edition, John Wiley & Sons, Inc., (1997) (reproduced there with permission from IUPAC), unless reference is made to the Previous IUPAC form noted with Roman numerals (also appearing in the same), or unless otherwise noted.

As used herein, an “alkyl” includes linear, branched and cyclic paraffin radicals that are deficient by one hydrogen. Thus, for example, CH₃ (“methyl”) and CH₂CH₃ (“ethyl”) are examples of alkyls.

As used herein, an “alkenyl” includes linear, branched and cyclic olefin radicals that are deficient by one hydrogen; alkynyl radicals include linear, branched and cyclic acetylene radicals deficient by one hydrogen radical.

As used herein, “aryl” groups include phenyl, naphthyl, pyridyl and other radicals whose molecules have the ring structure characteristic of benzene, naphthylene, phenanthrene, anthracene, etc. It is understood that an “aryl’ group can be a C₆ to C₂₀ aryl group. For example, a C₆H₅ aromatic structure is an “phenyl”, a C₆H₄ 2 aromatic structure is an “phenylene”. An “arylalkyl” group is an alkyl group having an aryl group pendant therefrom. It is understood that an “aralkyl” group can be a (C₇ to C₂₀ aralkyl group. An “alkylaryl” is an aryl group having one or more alkyl groups pendant therefrom.

As used herein, an “alkylene” includes linear, branched and cyclic hydrocarbon radicals deficient by two hydrogens. Thus, CH₂ (“methylene”) and CH₂CH₂ (“ethylene”) are examples of alkylene groups. Other groups deficient by two hydrogen radicals include “arylene” and “alkenylene”.

As used herein, the term “heteroatom” includes any atom selected from the group consisting of B, Al, Si, Ge, N, P, O, and S. A “heteroatom-containing group” is a hydrocarbon radical that contains a heteroatom and may contain one or more of the same or different heteroatoms, and from 1 to 3 heteroatoms in a particular embodiment. Non-limiting examples of heteroatom-containing groups include radicals (monoradicals and diradicals) of imines, amines, oxides, phosphines, ethers, ketones, oxoazolines heterocyclics, oxazolines, and thioethers.

As used herein, the term “substituted” means that one or more hydrogen atoms in a parent structure has been independently replaced by a substituent atom or group.

The asymmetrical hafnium metallocenes having an n-propyl cyclopentadienyl ligand discussed herein can be utilized to make catalyst compositions. These compositions include the asymmetrical hafnium metallocenes discussed herein and an activator. The asymmetrical hafnium metallocenes discussed herein and the activator can be contacted to make a catalyst composition. One or more embodiments provide that the activator is an alkylaluminoxane such as methylaluminoxane. As used herein, “activator” refers to any compound or combination of compounds, supported, or unsupported, which can activate a complex or a catalyst component, such as by creating a cationic species of the catalyst component. For example, this can include the abstraction of at least one leaving group, e.g., the “X” groups described herein, from the metal center of the complex/catalyst component, e.g., the asymmetrical hafnium metallocene having an n-propyl cyclopentadienyl ligand of Structure (I). The activator may also be referred to as a “co-catalyst”. As used herein, “leaving group” refers to one or more chemical moieties bound to a metal atom and that can be abstracted by an activator, thus producing a species active towards olefin polymerization. Various catalyst compositions, e.g., olefin polymerization catalyst compositions, are known in the art and different known catalyst composition components may be utilized. Various amounts of known catalyst composition components may be utilized for different applications.

The asymmetrical hafnium metallocenes having an n-propyl cyclopentadienyl ligand discussed herein can be utilized to make spray-dried compositions. As used herein, “spray-dried composition” refers to a composition that includes a number of components that have undergone a spray-drying process. Various spray-drying process are known in the art and are suitable for forming the spray-dried compositions disclosed herein. One or more embodiments provide that the spray-dried composition comprises a trim composition.

In one or more embodiments, the spray-drying process may comprise atomizing a composition including the asymmetrical hafnium metallocene having an n-propyl cyclopentadienyl ligand discussed herein. A number of other known components may be utilized in the spray-drying process. An atomizer, such as an atomizing nozzle or a centrifugal high speed disc, for example, may be used to create a spray or dispersion of droplets of the composition. The droplets of the composition may then be rapidly dried by contact with an inert drying gas. The inert drying gas may be any gas that is non-reactive under the conditions employed during atomization, such as nitrogen, for example. The inert drying gas may meet the composition at the atomizer, which produces a droplet stream on a continuous basis. Dried particles of the composition may be trapped out of the process in a separator, such as a cyclone, for example, which can separate solids formed from a gaseous mixture of the drying gas, solvent, and other volatile components.

A spray-dried composition may have the form of a free-flowing powder, for instance. After the spray-drying process, the spray-dried composition and a number of known components may be utilized to form a slurry. The spray-dried composition may be utilized with a diluent to form a slurry suitable for use in olefin polymerization, for example. In one or more embodiments, the slurry may be combined with one or more additional catalysts or other known components prior to delivery into a polymerization reactor.

In one or more embodiments, the spray-dried composition may be formed by contacting a spray dried activator particle, such as spray dried MAO, with a solution of the asymmetrical hafnium metallocene having an n-propyl cyclopentadienyl ligand discussed herein. Such a solution typically may be made in an inert hydrocarbon solvent, for instance, and is sometimes called a trim solution. Such a spray-dried composition comprised of contacting a trim solution of the asymmetrical hafnium metallocene having an n-propyl cyclopentadienyl ligand with a spray dried activator particle, such as spray-dried MAO, may be made in situ in a feed line heading into a gas phase polymerization reactor by contacting the trim solution with a slurry, typically in mineral oil, of the spray-dried activator particle.

Various spray-drying conditions may be utilized for different applications. For instance, the spray-drying process may utilize a drying temperature from 75 to 185° C. Other drying temperatures are possible, where the temperature can depend on the metallocene and activator particle. Various sizes of orifices of the atomizing nozzle employed during the spray-drying process may be utilized to obtain different particle sizes. Alternatively, for other types of atomizers such as discs, rotational speed, disc size, and number/size of holes may be adjusted to obtain different particle sizes. One or more embodiments provide that a filler may be utilized in the spray-drying process. Different fillers and amounts thereof may be utilized for various applications.

The asymmetrical hafnium metallocenes having an n-propyl cyclopentadienyl ligand discussed herein may be utilized to make a polyolefin composition, e.g., a polymer. For instance, the asymmetrical hafnium metallocene having an n-propyl cyclopentadienyl ligand may be activated, i.e., with an activator, to make a catalyst. One or more embodiments provide that the spray-dried compositions include an activator. As used herein, “activator” refers to any compound or combination of compounds, supported, or unsupported, which can activate a complex or a catalyst component, such as by creating a cationic species of the catalyst component, e.g., to provide the catalyst. The activator may also be referred to as a “co-catalyst”. The activator can include a Lewis acid or a non-coordinating ionic activator or ionizing activator, or any other compound including Lewis bases, aluminum alkyls, and/or conventional-type co-catalysts. Activators include methylaluminoxane (MAO) and modified methylaluminoxane (MMAO), among others. One or more embodiments provide that the activator is methylaluminoxane. Activating conditions are well known in the art. Known activating conditions may be utilized.

A molar ratio of metal, e.g., aluminum, in the activator to hafnium in the asymmetrical hafnium metallocene having an n-propyl cyclopentadienyl ligand may be 1500:1 to 0.5:1, 300:1 to 1:1, or 150:1 to 1:1. One or more embodiments provide that the molar ratio of in the activator to hafnium in the asymmetrical hafnium metallocene having an n-propyl cyclopentadienyl ligand is at least 75:1. One or more embodiments provide that the molar ratio of in the activator to hafnium in the asymmetrical hafnium metallocene having an n-propyl cyclopentadienyl ligand is at least 100:1. One or more embodiments provide that the molar ratio of in the activator to hafnium in the asymmetrical hafnium metallocene having an n-propyl cyclopentadienyl ligand is at least 150:1.

The asymmetrical hafnium metallocenes having an n-propyl cyclopentadienyl ligand discussed herein, as well as a number of other components, can be supported on the same or separate supports, or one or more of the components may be used in an unsupported form. Utilizing the support may be accomplished by any technique used in the art. One or more embodiments provide that the spray-drying process is utilized. The support may be functionalized. One or more embodiments provide that the spray-dried compositions include a support.

A “support”, which may also be referred to as a “carrier”, refers to any support material, including a porous support material, such as talc, inorganic oxides, and inorganic chlorides. Other support materials include resinous support materials, e.g., polystyrene, functionalized or crosslinked organic supports, such as polystyrene divinyl benzene polyolefins or polymeric compounds, zeolites, clays, or any other organic or inorganic support material and the like, or mixtures thereof.

Support materials include inorganic oxides that include Group 2, 3, 4, 5, 13 or 14 metal oxides. Some preferred supports include silica, fumed silica, alumina, silica-alumina, and mixtures thereof. Some other supports include magnesia, titania, zirconia, magnesium chloride, montmorillonite, phyllosilicate, zeolites, talc, clays, and the like. Also, combinations of these support materials may be used, for example, silica-chromium, silica-alumina, silica-titania and the like. One or more embodiments provide that the support is silica, One or more embodiments provide that the support is hydrophobic fumed silica. One or more embodiments provide that the support is dehydrated silica. Additional support materials may include porous acrylic polymers, nanocomposites, aerogels, spherulites, and polymeric beads. An example of a support is fumed silica available under the trade name Cabosil™ TS-610, or other TS- or TG-series supports, available from Cabot Corporation. Fumed silica is typically a silica with particles 7 to 30 nanometers in size that has been treated with dimethylsilyldichloride such that a majority of the surface hydroxyl groups are capped.

The asymmetrical hafnium metallocenes having an n-propyl cyclopentadienyl ligand discussed herein and an olefin can be contacted under polymerization conditions to make a polymer, e.g., a polyolefin composition. The polymerization process may be a solution polymerization process, a suspension polymerization process, a slurry polymerization process, and/or a gas phase polymerization process. The polymerization process may utilize using known equipment and reaction conditions, e.g., known polymerization conditions. The polymerization process is not limited to any specific type of polymerization system. The polymer can be utilized for a number of articles, such as rotomolded articles.

One or more embodiments provide that the polyolefin compositions are made utilizing a gas-phase reactor system. One or more embodiments provide that a single gas-phase reactor, e.g., in contrast to a series of reactors, is utilized. In other words, polymerization reaction occurs in only one reactor. For instance, the polymers can be made utilizing a fluidized bed reactor. Gas-phase reactors are known and known components may be utilized for the fluidized bed reactor.

As used herein an “olefin,” which may be referred to as an “alkene,” refers to a linear, branched, or cyclic compound including carbon and hydrogen and having at least one double bond. As used herein, when a polyolefin, polyolefin composition, polymer, and/or copolymer is referred to as comprising, e.g., being made from, an olefin, the olefin present in such polymer or copolymer is the polymerized form of the olefin. For example, when a copolymer is said to have an ethylene content of 75 wt % to 95 wt %, it is understood that the polymer unit in the copolymer is derived from ethylene in the polymerization reaction(s) and the derived units are present at 75 wt % to 95 wt %, based upon the total weight of the polymer. A higher α-olefin refers to an α-olefin having 3 or more carbon atoms.

Polyolefins made with the compositions discussed herein can be made from olefin monomers such as ethylene (i.e., polyethylene), or propylene (i.e., polypropylene), among other provided herein, where the polyolefin is a homopolymer made only from the olefin monomer (e.g., made with 100 wt. % ethylene or 100 wt. % propylene). Alternatively, polyolefins compositions discussed herein can made from olefin monomers such as ethylene, i.e., polyethylene, and linear or branched higher alpha-olefin monomers containing 3 to 20 carbon atoms. Examples of higher alpha-olefin monomers include, but are not limited to, propylene, butene, pentene, 1-hexene, and 1-octene. Examples of polyolefins include ethylene-based polymers, having at least 50 wt % ethylene, including ethylene-1-butene, ethylene-1-hexene, and ethylene-1-octene copolymers, among others. One or more embodiments provide that the polyolefin compositions can include from 50 to 99.9 wt % of units derived from ethylene based on a total weight of the polymer. All individual values and subranges from 50 to 99.9 wt % are included; for example, the polymer can include from a lower limit of 50, 60, 70, 80, or 90 wt % of units derived from ethylene to an upper limit of 99.9, 99.7, 99.4, 99, 96, 93, 90, or 85 wt % of units derived from ethylene based on the total weight of the polyolefin compositions. The polyolefin compositions can include from 0.1 to 50 wt % of units derived from comonomer based on the total weight of the polyolefin compositions. One or more embodiments provide that ethylene is utilized as a monomer and hexene is utilized as a comonomer.

As mentioned, the polymers made with the compositions disclosed herein can be made in a fluidized bed reactor. The fluidized bed reactor can have a reaction temperature from 10 to 130° C. All individual values and subranges from 10 to 130° C. are included; for example, the fluidized bed reactor can have a reaction temperature from a lower limit of 10, 20, 30, 40, 50, or 55° C. to an upper limit of 130, 120, 110, 100, 90, 80, 70, or 60° C.

The fluidized bed reactor can have an ethylene partial pressure from 30 to 250 pounds per square inch (psi). All individual values and subranges from 30 to 250 are included; for example, the fluidized bed reactor can have an ethylene partial pressure from a lower limit of 30, 45, 60, 75, 85, 90, or 95 psi to an upper limit of 250, 240, 220, 200, 150, or 125 psi.

One or more embodiments provide that ethylene is utilized as a monomer and hexene is utilized as a comonomer. The fluidized bed reactor can have a comonomer to ethylene mole ratio, e.g., C₆/C₂, from 0.0001 to 0.100. All individual values and subranges from 0.0001 to 0.100 are included; for example, the fluidized bed reactor can have a comonomer to ethylene mole ratio from a lower limit of 0.0001, 0.0005, 0.0007, 0.001, 0.0015, 0.002, 0.007, or 0.010 to an upper limit of 0.100, 0.080, or 0.050.

When hydrogen is utilized for a polymerization process, the fluidized bed reactor can have a hydrogen to ethylene mole ratio (H₂/C₂) from 0.00001 to 0.90000, for instance. All individual values and subranges from 0.00001 to 0.90000 are included; for example, the fluidized bed reactor can have a H₂/C₂ from a lower limit of 0.00001, 0.00005, or 0.00008 to an upper limit of 0.90000, 0.500000, 0.10000, 0.01500, 0.00700, or 0.00500. One or more embodiments provide that hydrogen is not utilized.

The comonomer distribution, or short chain branching distribution, in an ethylene/α-olefin copolymer can be characterized as either normal (also referred to as having a Zeigler-Natta distribution), reverse (also referred to as having a Broad Orthogonal Composition Distribution (BOCD), or flat. Several reported methods are utilized to quantify a BOCD. Herein, a simple line fit is utilized such that the normal or reverse nature of the comonomer distribution can be quantified by the molecular weight comonomer distribution index (MWCDI), which is the slope of the linear regression of the comonomer distribution taken from a compositional GPC measurement, wherein the x-axis is Log (MW) and the y-axis is weight percent of comonomer. Composition data was omitted where the MW detector response was <0.1. A reverse comonomer distribution is defined when the MWCDI>0 and a normal comonomer distribution is defined when the MWCDI<0. When the MWCDI=0 the comonomer distribution is said to be flat. Additionally, the MWCDI quantifies the magnitude of the comonomer distribution. Comparing two polymers that have MWCDI>0, the polymer with the greater MWCDI value is defined to have a greater, i.e., increased, BOCD; in other words, the polymer with the greater MWCDI value has a greater reverse comonomer distribution. Polymers with a relatively greater MWCDI, i.e., BOCD, can provide one or more improved physical properties, as compared to polymers having a relatively lesser MWCDI.

The polyolefin compositions disclosed herein are unimodal, e.g., in contrast to bimodal. As used herein, “unimodal” refers to polyolefin compositions that can be characterized by having one peak (one maxima) in a GPC chromatogram showing the molecular weight distribution. Furthermore, a unimodal composition is a composition that is made by utilizing a single catalyst, e.g., a single polyethylene catalyst, in a single reactor. This distinguishes the unimodal composition, as defined above, from bimodal compositions that may appear to have one peak in the GPC chromatogram showing the molecular weight distribution. These bimodal compositions are those that are made by one or more polyethylene catalysts in a staged reactor process, typically a dual reactor process including but not limited to two solution polyethylene reactors, or two gas phase polymer reactors, or two slurry phase polymerization reactors, or combinations thereof such as a sequential slurry and gas phase reactors, such that two different polymers of different densities, and optionally molecular weights are made in the different reactors. The two or more reactors may be in series or parallel or some combination thereof. These approaches can provide an improved MWCDI compared to what the individual polyethylene catalyst or catalysts can achieve independently. In the case where the molecular weight of two components of the bimodal are similar enough the polymer may appear to have a single peak in a GPC chromatogram. As this composition required at least two reactors and one or more polyethylene catalysts this is defined as a bimodal composition. Additionally, two or more polyethylene catalysts in a single solution, slurry, or gas phase reactor may produce such a bimodal polymer as described above that appears to have a single peak in a GPC chromatogram showing the molecular weight distribution. This would also be defined as a bimodal polymer composition.

The polyolefin compositions disclosed herein can have a MWCDI from 0.10 to 10.00. All individual values and subranges from 0.10 to 10.00 are included; for example, the polyolefin composition can have a MWCDI from a lower limit of 0.10, 0.50, 1.00, 1.50, or 2.50 to an upper limit of 10.00, 9.00, 8.00, 8.50, or 8.35.

One or more embodiments provide that when the polyolefin composition disclosed herein has a density from 0.925 to 0.939 g/cm3 the MWCDI is greater than 2.5, e.g., from 2.5 to 10.00.

One or more embodiments provide that when the polyolefin composition disclosed herein has a density from 0.940 to 0.945 g/cm3 the MWCDI is greater than 1.5, e.g., from 1.5 to 10.00.

One or more embodiments provide that when the polyolefin composition disclosed herein has a density from 0.946 to 0.950 g/cm³ the MWCDI is greater than 1.0, e.g., from 1.0 to 10.00.

One or more embodiments provide that when the polyolefin composition disclosed herein has a density from 0.951 to 0.960 g/cm³ the MWCDI is greater than 0, e.g., from 0.1 to 10.00.

One or more embodiments provide that the polyolefin compositions disclosed herein have a MWCDI vs density relationship such that: MWCDI>−161.2*Density+152.5. This relationship is surprising.

One or more embodiments provide that the polyolefin compositions disclosed herein have a MWCDI vs density relationship such that: MWCDI>−161.2*Density+154. This relationship is surprising.

The polyolefin compositions disclosed herein can have a density from 0.925 to 0.960 g/cm³. All individual values and subranges from 0.925 to 0.960 g/cm³ are included; for example, the polyolefin composition can have a density from a lower limit of 0.925, 0.930, or 0.935 g/cm³ to an upper limit of 0.960 or 0.956 g/cm³. Density can be determined by according to ASTM D792.

The polyolefin compositions disclosed herein can have an ESCR F₅₀>20 hours, e.g., from 21 hours to 600 hours. For example, one or more embodiments provide that the polyolefin composition can have an ESCR F₅₀ from a lower limit of 300, 350, or 400 hours to an upper limit of 600, 550, or 500 hours. ESCR F₅₀ can be determined according to by ASTM D-1693, Method B, in 10% by volume aqueous Igepal CO-630 solution.

The polyolefin compositions disclosed herein can have a zero-shear viscosity (ZSV) value from 800 to 4,000 Pa*s. All individual values and subranges from 800 to 4,000 Pa*s are included; for example, the polyolefin composition can have a ZSV from a lower limit of 800, 900, or 1,000 Pa*s to an upper limit of 4,000 or 3,500 Pa*s.

ZSV can be determined as follows.

For preparation, a test sample was placed into a 9.75 in. by 10.25 in. rectangular chase of thickness 1.85 mm and compression molded at a pressure of 25,000 lbs for 6.5 min. at 190° C. After cooling to room temperature, the resulting sample block was subjected to a 25 mm diameter die cutter to extract disk-shaped samples for creep testing.

Prior to the creep measurement, a DMS (dynamic mechanical spectroscopy) frequency sweep was conducted using 25 mm parallel plates at frequencies ranging from 0.1 to 100 rad/s. Test gap separating the plates was 1.5 mm and a strain that satisfies linear viscoelastic conditions was utilized, typically 10% strain. Each test was conducted under nitrogen atmosphere and isothermal conditions at 190° C. To initiating the DMS test, the rheometer oven first allowed to equilibrate at the desired testing temperature for at least 30 min before loading the sample into the test geometry. The sample was then equilibrated in the oven, with the door closed, for 5 min. The test gap was then set to 1.5 mm, which produced an axial force on the sample. Once the sample relaxed this axial force, the oven was quickly opened, and the sample was trimmed so that no bulge was present. The DMS measurement was then initiated after reclosing the oven. During the test, the shear elastic modulus (G′), viscous modulus (G″) and complex viscosity were measured.

Immediately following the DMS frequency sweep measurement, under the same temperature and atmospheric conditions, the creep test was initiated using an applied stress of 20 Pa. During the test, a log-log plot of creep compliance with respect to time is continuously monitored for the achievement of steady state conditions, which is noted by obtaining a slope between 0.97 and unity in the plot; the creep test is stopped once steady state conditions are obtained. Afterwards, the measured shear strain during the test is plotted against the time elapsed in order to analyze the shear rate at the end of testing. The zero-shear viscosity of the melt sample was then obtained by dividing the applied shear stress (20 Pa) by the shear rate noted previously.

Lastly, the melt sample was evaluated for signs of degradation, whether it be due to cross-linking or chain scission, by subjecting the sample to an additional DMS frequency sweep measurement immediately following the creep test (please note that the DMS test is consistently conducted at the same temperature and atmosphere as the creep measurement and with 10% strain). The sample is considered thermally stable when the viscosity documented at 0.1 rad/s is within 5% deviation from the viscosity, of the same frequency, that was measured in the initial DMS test that was performed before the creep assessment.

All creep, including the associated DMS frequency sweep, tests were conducted on either the DHR-3 or AR-G2 rheometers, both of which were manufactured by TA Instruments. Data analyses were conducted via TA Instruments TRIOS software.

The polyolefin compositions disclosed herein can have a secant modulus at 2% from 70 to 200 ksi. All individual values and subranges from 70 to 200 ksi are included; for example, the polyolefin composition can have a secant modulus at 2% from a lower limit of 70, 80, or 85 ksi to an upper limit of 200, 175, or 160 ksi. Secant Modulus at 2% can be determined according to ASTM D790 (0.45 in/min).

The polyolefin compositions disclosed herein can have a melt index (I₂) from 1.0 to 10 dg/min. 12 can be determined according to ASTM D1238 (190° C., 2.16 kg). All individual values and subranges from 1.0 to 10 dg/min are included; for example, the polyolefin composition can have an I₂ from a lower limit of 1.0, 1.5, or 2.0 dg/min to an upper limit of 10, 9, or 8 dg/min.

The polyolefin compositions disclosed herein can have a melt index (121) from 10 to 250 dg/min. 121 can be determined according to ASTM D1238 (190° C., 21.6 kg). All individual values and subranges from 10 to 250 dg/min are included; for example, the polyolefin composition can have an |21 from a lower limit of 10, 15, or 25 dg/min to an upper limit of 250, 200, or 175 dg/min.

The polyolefin compositions disclosed herein can have a weight average molecular weight (Mw) from 50,000 to 120,000 g/mol. All individual values and subranges from 50,000 to 120,000 g/mol are included; for example, the polyolefin composition can have an Mw from a lower limit of 50,000, 55,000 or 60,000 g/mol to an upper limit of 120,000, 110,000, or 100,000 g/mol. Mw can be determined by gel permeation chromatography (GPC), as is known in the art. GPC is discussed herein.

The polyolefin compositions disclosed herein can have a number average molecular weight (Mn) from 17,000 to 40,000 g/mol. All individual values and subranges from 17,000 to 40,000 g/mol are included; for example, the polyolefin composition can have an Mn from a lower limit of 17,000, 18,500, or 20,000 g/mol to an upper limit of 40,000, 38,000 or 35,000 g/mol. Mn can be determined by GPC.

The polyolefin compositions disclosed herein can have a Z-average molecular weight (Mz) from 120,000 to 300,000 g/mol. All individual values and subranges from 120,000 to 300,000 g/mol are included; for example, the polyolefin composition can have an Mz from a lower limit of 120,000, 130,000, or 150,000 g/mol to an upper limit of 300,000, 275,000, or 250,000 g/mol. Mz can be determined by GPC.

The polyolefin compositions disclosed herein can have a weight average molecular weight to number average molecular weight ratio (Mw/Mn) from 2.0 to 3.5. All individual values and subranges from 2.0 to 3.5 are included; for example, the polyolefin composition can have an Mw/Mn from a lower limit of 2.0 2.5, 2.75, or 2.8 to an upper limit of 3.5, 3.25, or 3.0 Mw/Mn may also be referred to as molecular weight distribution or “MWD”.

Compositional Conventional GPC is discussed as follows.

A chromatographic system consisted of a PolymerChar GPC-IR (Valencia, Spain) high temperature GPC chromatograph equipped with an internal IR5 infra-red detector (IR5). The autosampler oven compartment was set at 160° C. and the column compartment was set at 150° C. The columns used were 4 Agilent “Mixed A” 30 cm 20-micron linear mixed-bed columns. The chromatographic solvent used was 1,2,4 trichlorobenzene and contained 200 ppm of butylated hydroxytoluene (BHT). The solvent source was nitrogen sparged. The injection volume used was 200 microliters and the flow rate was 1.0 milliliters/minute.

Calibration of the GPC column set was performed with 21 narrow molecular weight distribution polystyrene standards with molecular weights ranging from 580 to 8,400,000 g/mol and were arranged in 6 cocktail mixtures with at least a decade of separation between individual molecular weights. The standards were purchased from Agilent Technologies. The polystyrene standards were prepared at 0.025 grams in 50 milliliters of solvent for molecular weights equal to or greater than 1,000,000, and 0.05 grams in 50 milliliters of solvent for molecular weights less than 1,000,000. The polystyrene standards were pre-dissolved at 80° C. with gentle agitation for 30 minutes then cooled and the room temperature solution is transferred cooled into the autosampler dissolution oven at 160° C. for 30 minutes. The polystyrene standard peak molecular weights were converted to polyethylene molecular weights using Equation 1 (as described in Williams and Ward, J. Polym. Sci., Polym. Let., 6, 621 (1968)).:

$${M}_{polyethylene} = A \times {( {M}_{polystyrene} )}^{B} \qquad ( EQ1 )$$

where M is the molecular weight, A has a value of 0.4061 and B is equal to 1.0. A fifth order polynomial was used to fit the respective polyethylene-equivalent calibration points.

The total plate count of the GPC column set was performed with decane which was introduced into blank sample via a micropump controlled with the PolymerChar GPC-IR system. The plate count for the chromatographic system should be greater than 18,000 for the 4 Agilent “Mixed A” 30 cm 20-micron linear mixed-bed columns.

Samples were prepared in a semi-automatic manner with the PolymerChar Instrument Control Software, wherein the samples were weight-targeted at 2 mg/ml, and the solvent (contained 200 ppm BHT) was added to a pre nitrogen-sparged septa-capped vial, via the PolymerChar high temperature autosampler. The samples were dissolved for 2 hours at 160° C. under low speed shaking.

The calculations of Mn (GPC), MW (GPC), and Mz (GPc) were based on GPC results using the internal IR5 detector (measurement channel) of the PolymerChar GPC-IR chromatograph according to Equations 2-4, using PolymerChar GPCONE software, the baseline-subtracted IR chromatogram at each equally-spaced data collection point (i), and the polyethylene equivalent molecular weight obtained from the narrow standard calibration curve for the point (i) from Equation 1.

$${Mn}_{( GPC )} = \frac{{\sum }^{i} {IR}_{i}}{{\sum }^{i} ( {IR}_{i} / {M}_{{polyethylene}_{i}} )} \qquad ( EQ 2 )$$

$${Mw}_{( GPC )} = \frac{{\sum }^{i} ( {IR}_{i} * {M}_{{polyethylene}_{i}} )}{{\sum }^{i} {IR}_{i}} \qquad ( EQ 3 )$$

$${Mz}_{( GPC )} = \frac{{\sum }^{i} ( {IR}_{i} * {M}_{{polyethylene}_{i}}^{2} )}{{\sum }^{i} ( {IR}_{i} * {M}_{{polyethylene}_{i}} )} \qquad ( EQ 4 )$$

To monitor the deviations over time, a flowrate marker (decane) was introduced into each sample via a micropump controlled with the PolymerChar GPC-IR system. This flowrate marker (FM) was used to linearly correct the pump flowrate (Flowrate (nominal)) for each sample by RV alignment of the respective decane peak within the sample (RV_{(FM Sample)}) to that of the decane peak within the narrow standards calibration (RV_{(FM Calibrated)}). Any changes in the time of the decane marker peak are then assumed to be related to a linear-shift in flowrate (Flowrate_{(effective)}) for the entire run. After calibrating the system based on a flow marker peak, the effective flowrate (with respect to the narrow standards calibration) is calculated as Equation 5. Processing of the flow marker peak was done via the PolymerChar GPCONE Software. Acceptable flowrate correction is such that the effective flowrate should be within +/−0.5% of the nominal flowrate.

$$Flowrate ( effective ) = Flowrate ( nominal ) * ( {RV}_{( F M Calibrated )} / {RV}_{( F M Sample )} ) \qquad ( EQ5 )$$

IR5 GPC Octene Composition Calibration is discussed as follows.

A calibration for the IR5 detector rationing was performed using at least ten ethylene-based polymer standards (Octene as comonomer) made by single-site metallocene catalyst from a single reactor in solution process (polyethylene homopolymer and ethylene/octene copolymers) of a narrow SCB distribution and known comonomer content (as measured by ¹³C NMR Method, Qiu et al., Anal. Chem. 2009, 81, 8585-8589), ranging from homopolymer (0 SCB/1000 total C) to approximately 40 SCB/1000 total C, where total C=carbons in backbone+carbons in branches. Each standard had a weight-average molecular weight from 36,000 g/mole to 126,000 g/mole measured by GPC. Each standard had a molecular weight distribution (Mw/Mn) from 2.0 to 2.5. Polymer properties for the SCB standards are shown in Table A.

TABLE A
Copolymer Standards

| Wt % | IR5 Area | SCB/1000 | | |
|---|---|---|---|---|
| Comonomer | ratio | Total C | Mw | Mw/Mn |
| 23.1 | 0.2411 | 28.9 | 37,300 | 2.22 |
| 14.0 | 0.2152 | 17.5 | 36,000 | 2.19 |
| 0.0 | 0.1809 | 0.0 | 38,400 | 2.20 |
| 35.9 | 0.2708 | 44.9 | 42,200 | 2.18 |
| 5.4 | 0.1959 | 6.8 | 37,400 | 2.16 |
| 8.6 | 0.2043 | 10.8 | 36,800 | 2.20 |
| 39.2 | 0.2770 | 49.0 | 125,600 | 2.22 |
| 1.1 | 0.1810 | 1.4 | 107,000 | 2.09 |
| 14.3 | 0.2161 | 17.9 | 103,600 | 2.20 |
| 9.4 | 0.2031 | 11.8 | 103,200 | 2.26 |

The “IR5 Area Ratio (or “IR5_{Methyl Channel Area}/IR5_{Measurement Channel Area}”)” of “the baseline-subtracted area response of the IR5 methyl channel sensor” to “the baseline-subtracted area response of IR5 measurement channel sensor” (standard filters and filter wheel as supplied by PolymerChar: Part Number IR5 FWM01 included as part of the GPC-IR instrument) was calculated for each of the “Copolymer” standards. A linear fit of the Wt % Comonomer frequency versus the “IR5 Area Ratio” was constructed in the form of the following Equation 6:

$$Wt \% Comonomer = {A}_{0} + [ {A}_{1} \times ( IR {5}_{Methyl Channel Area} / IR {5}_{Measurement Channel Area} ) ] \qquad ( EQ 6 )$$

where A₀ is the “Wt % Comonomer” intercept at an “IR5 Area Ratio” of zero, and A₁ is the slope of the “Wt % Comonomer” versus “IR5 Area Ratio” and represents the increase in the Wt % Comonomer as a function of “IR5 Area Ratio.” The IR5 area ratio is equal to the IR5 height ratio for narrow PDI and narrow SCBD standard materials.

The polyolefin compositions disclosed herein can have a −40° C. Charpy impact strength greater than 40 J/m. For instance, the polymers can have a −40° C. Charpy impact strength from 40 J/m to 100 J/m. All individual values and subranges from 40 J/m to 100 J/m are included; for example, the polyolefin composition can have a −40° C. Charpy impact strength a lower limit of 40, 42, or 44 J/m to an upper limit of 100, 85, or 75 J/m. −40° C. Charpy impact strength can be determined in accordance with ISO 179 at −40° C.

Surprisingly, polyolefin compositions disclosed herein can have a desired higher stiffness as measured by Secant Modulus at 1%, as compared to other polyolefin compositions. For example, polyolefin compositions disclosed herein have a Secant Modulus at 1% vs density relationship such that: 1% secant modulus >4137.4*density−3770.

The polyolefin compositions disclosed herein can advantageously, e.g., due to providing a reverse comonomer distribution, have an improved low temperature impact strength, an improved ESCR F₅₀, and/or an improved zero-shear viscosity, for a rotomolding process to make a rotomolding article. Rotational molding, also known as rotomolding, is a well-known process, which can be used to produce hollow plastic articles, for instance.

The rotomolding process can be undertaken by loading the polymer made with the compositions disclosed herein into a mold “shell”, then rotating the mold (usually, on two axes) while heating it to a temperature above the melting point of the polymer. The melted polymer flows through the mold cavity under the forces caused by the rotation of the apparatus. The rotation continues for sufficient time to allow the molten polymer to cover the surface of the mold. The mold is then cooled to permit the polymer to solidify. The final stage of the molding cycle is the removal of the part from the rotomolding machine. A number of known components may be utilized in the rotomolding process. Different rotomolding times can be utilized for various applications. Different rotomolding temperatures can be utilized for various applications. One or more embodiments provide that the rotomolding process occurs at a temperature from 110° C. to 400° C.

A number of aspects of the present disclosure are provided as follows.

Aspect 1 provides a polyolefin composition, wherein the polyolefin composition has: a density from 0.925 to 0.960 g/cm³; a melt index (I₂) from 1.0 to 10.0 dg/min; a Mn of 17,000 to 40,000; a Mw of 50,000 to 120,000; a Mz of 120,000 to 300,000; a molecular weight distribution (Mw/Mn) from 2.0 to 3.5; and a molecular weight comonomer distribution index vs density relationship such that: molecular weight comonomer distribution index>−161.2*Density+152.5

Aspect 2 provides the polyolefin composition of aspect 1, wherein the polyolefin composition has molecular weight comonomer distribution index vs density relationship such that: molecular weight comonomer distribution index>−161.2*Density +154.

Aspect 3 provides the polyolefin composition of any one of aspects 1-2, wherein the polyolefin composition has a −40° C. Charpy impact strength greater than 40 J/m.

Aspect 4 provides the polyolefin composition of any one of aspects 1-3, wherein the polyolefin composition has a secant modulus at 1% vs density relationship such that: 1% secant modulus >4137.4*density-3770.

Aspect 5 provides the polyolefin composition of any one of aspects 1-4, wherein when the density is from 0.925 to 0.939 g/cm³ the molecular weight comonomer distribution index is greater than 2.5, when the density is from 0.940 to 0.945 g/cm³ the molecular weight comonomer distribution index is greater than 1.5, when the density is from 0.946 to 0.950 g/cm³ the molecular weight comonomer distribution index is greater than 1.0, and when the density is from 0.951 to 0.960 g/cm³ the molecular weight comonomer distribution index is greater than 0.

Aspect 6 provides the polyolefin composition of any one of aspects 1-5, wherein the polyolefin composition has an environmental stress cracking resistance (ESCR) F₅₀>20 hours (ASTM D-1693, Method B, 10% Igepal).

Aspect 7 provides the polyolefin composition of any one of aspects 1-6, wherein the polyolefin composition is unimodal.

Aspect 8 provides a rotomolding article made with the polyolefin composition of any one of aspects1-7.

Aspect 9 provides a method for making the polyolefin composition of any one of aspects 1-7, the method comprising: making a catalyst composition utilizing an asymmetrical hafnium metallocene; and contacting the catalyst composition and ethylene and, optionally, a comonomer selected from the group consisting of propene and a (C₄-C₂₀) alpha-olefins to make the polyolefin composition.

Aspect 10 provides a method for making the polyolefin composition of any one of aspects 1-7, the method comprising:
making a catalyst composition utilizing an asymmetrical hafnium metallocene;
and contacting the catalyst composition and ethylene and, optionally, a comonomer selected from the group consisting of propene and a (C₄-C₂₀) alpha-olefins to make the polyolefin composition.

Aspect 11 provides the method of any one of aspects 9 or 10, wherein the asymmetrical hafnium metallocene has an n-propyl cyclopentadienyl ligand and the asymmetrical hafnium metallocene can represented by structure (I):

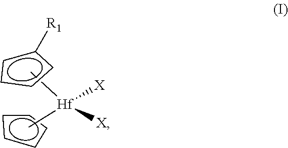

wherein R¹ n-propyl; and each X is independently a leaving group.

### Examples

Hafnium complex I: (n-Propylcylopentadienyl) hafnium trichloride, dimethoxyethane adduct, which may be represented by the following formula:

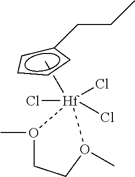

was synthesized as follows. The (n-propylcylopentadienyl) hafnium trichloride dimethoxyethane adduct was synthesized as follows (e.g., by adapting the procedure described in WO2016/168448A1 by Harlan). Bis(n-propylcyclopentadienyl) hafnium dichloride was commercially obtained from TCI; bis(n-propylcyclopentadienyl) hafnium dichloride (25.1 g, 54.1 mmol) was heated to 140° C. in a 100 mL round-bottom flask until melted. HfCl₄ (17.5 g, 54.6 mmol) was added to the flask as a solid powder. The contents of the flask were heated at 140° C. for approximately 30 minutes and formed a brown viscous liquid. The 100 mL round bottom flask was attached to a short path distillation apparatus, which consisted of a glass tube (90° bend) that was attached to a Schlenk flask. A vacuum was pulled through a stopcock of the Schlenk flask. Distillation was performed from 105° C. to 110° C. with 0.4 torr vacuum. In approximately one hour, it was observed that most of the material distilled/sublimed into the Schlenk flask or remained in the glass tube. The solid material in the u-tube was scraped out and combined with the material in the Schlenk flask. To this solid was added toluene (50 mL) and dimethoxyethane (50 mL). This was heated to reflux forming a solution, additional toluene (50 mL) was added. Upon cooling colorless needles formed. Pentane (200 mL) was added causing further formation of solid precipitate. The solid was isolated by filtration, washed with pentane (2×50 mL) and dried under vacuum to provide (n-propylcylopentadienyl) hafnium trichloride, dimethoxyethane adduct (42.2 g); cooling the combined supernatant and washings resulted an additional 2.6 g of product that was isolated.

An asymmetrical hafnium metallocene having an n-propyl cyclopentadienyl ligand, which may be represented by the following structure (II):

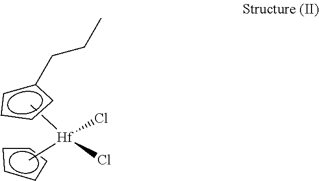

was synthesized as follows. For the above formula, R¹, as previously discussed, is (n-propyl). In a glove box, (n-propylcyclopentadienyl) hafniumtrichloride dimethoxy ethane adduct (0.75 g, 1.56 mmol) was added to a container (oven-dried 4 oz. glass jar); a teflon-coated stir bar and 40 mL of dry toluene (40 mL) were added to the container and the contents were stirred. The contents were observed to be grey and cloudy. Cyclopentadienyllithium (1 molar equivalent) was slowly added the container; then, the contents of the container were stirred for approximately 12 hours at approximately 20° C. NMR spectra indicated formation of Example 1-1, as well as some unreacted starting material. The contents of the container were further stirred for approximately 120 hours at approximately 20° C.; then, the contents of the container were filtered and volatiles were removed under reduced pressure. The solids were recrystallized from warm hexanes and toluene; the resultant solids (Example 1-1) were isolated (63.9% total yield after recrystallization). ¹H and ¹³C NMR spectra confirmed structure (II). 1H NMR (400 MHZ, Benzene-d₆) δ 5.86 (s, 3H), 5.77-5.72 (m, 2H), 5.57 (t, J=2.7 Hz, 2H), 2.63-2.54 (m, 2H), 1.48-1.35 (m, 2H), 0.80 (t, J=7.3 Hz, 3H). 13C NMR (101 MHZ, Benzene-d₆) δ 132.81, 115.78, 114.13, 110.86, 32.38, 24.34, 14.00.

A spray-dried composition utilizing the asymmetrical hafnium metallocene having an n-propyl cyclopentadienyl ligand, represented by structure (II), was made as follows. To a container (13 gallon tank) hydrophobic fumed silica (CABOSIL TS-610; 2.38 pounds) and a 10% solution (37.0 pounds) by weight of methylaluminoxane (MAO) in toluene were added while mixing. Then, the asymmetrical hafnium metallocene having an n-propyl cyclopentadienyl ligand (80 grams) and toluene (20 pounds) were added to the contents of the container while mixing. Then, the contents of the container were spray-dried (146° C. inlet temperature; 84° C. outlet temperature; 14 lbs/hr slurry inlet feed, 20000 rpm atomizer speed) to provide the spray-dried composition (4.1 pounds).

Example 1 (polyolefin composition) was made utilizing the spray-dried composition utilizing the asymmetrical hafnium metallocene having an n-propyl cyclopentadienyl ligand, represented by structure (II) as follows. The polymerization utilized a pilot scale fluidized bed gas phase polymerization reactor that included a reactor vessel containing a fluidized bed of a powder of ethylene/alpha-olefin copolymer, and a distributor plate disposed above a bottom head, and defining a bottom gas inlet, and having an expanded section, or cyclone system, at the top of the reactor vessel to decrease resin fines that may escape from the fluidized bed. The expanded section defined a gas outlet. The reactor further included a compressor blower that was utilized to continuously cycle gas around from out of the gas outlet in the expanded section in the top of the reactor vessel through a cycle loop down to and into the bottom gas inlet of the reactor and through the distributor plate and fluidized bed. The reactor further included a cooling system that removed heat of polymerization and maintained the fluidized bed at a target temperature. Compositions of gases such as ethylene, alpha-olefin, and hydrogen were fed into the reactor and monitored by an in-line gas chromatograph in the cycle loop to maintain specific concentrations that were used to control polymer properties. The spray-dried catalyst was fed as a slurry or dry powder into the reactor from high pressure devices, wherein the slurry was fed via a syringe pump and the dry powder was fed via a metered disk. The catalyst entered the fluidized bed in the lower ⅓ of the bed height. The polymerization system weighed the fluidized bed and included isolation ports that discharged the polymerization product from the reactor vessel in response to an increase of the fluidized bed weight as the polymerization reaction proceeded. Polymerization conditions are reported in Table 1.

Example 2 (polyolefin composition) was made as Example 1, with the changes shown in Table 1.

Various polymers were utilized as comparative examples: Comparative Example A (unimodal polymer obtained from UNIVATION TECHNOLOGIES, made with UCAT-J catalyst, density of 0.935 g/cm³, melt index (I₂) of 6.1 dg/min); Comparative Example B (unimodal polymer obtained from UNIVATION TECHNOLOGIES, made with UCAT-J catalyst, density of 0.935 g/cm³, melt index (I₂) of 5.5 dg/min); Comparative Example C (Commercial metallocene grade Lumicene M3581UV from TOTAL metallocene); Comparative Example D (Experimental polymer made with XCAT VP 100 catalyst, density of 0.935 g/cm³, melt index (I₂) of 7.2 dg/min); Comparative Example E (Commercial polymer from Dow, density of 0.941 g/cm³, melt index (I₂) of 2.0 dg/min; Comparative Example F (Commercial polymer Exxon HD 8660, density of 0.943 g/cm³, melt index (I₂) of 2.1 dg/min); Comparative Example G (Commercial polymer Nova Surpass 245, density of 0.946 g/cm³, melt index (I₂) of 1.8 dg/min); Comparative Example H (Experimental polymer from Dow, density of 0.946 g/cm³, melt index (I₂) of 2.0 dg/min).

A number of properties were determined for the polymers. The results are reported in Table 2-3. Melt index (I₂) was determined according to ASTM D1238 (190° C., 2.16 kg), melt index (I₅) was determined according to ASTM D1238 (190° C., 5 kg), melt index (121) was determined according to ASTM D1238 (190° C., 21.6 kg); Mw, Mn, Mz, and Mw/Mn were determined by GPC; molecular weight comonomer distribution index (MWCDI) was determined as discussed herein. ESCR F₅₀ was determined according to by ASTM D-1693, Method A and Method B, in 10% by volume aqueous Igepal CO-630 solution. Charpy impact strength was determined in accordance with ISO 179 at −40° C. Flex modulus, secant Modulus at 1%, and secant Modulus at 2% were determined according to ASTM D790 (0.45 in/min) and are reported in kilopounds per square inch (KSI). Heat distortion temperature was determined was determined according to ASTM D648. Zero-shear viscosity (ZSV) of the polymer was obtained as discussed herein.

TABLE 1

| | | Example | Example |
|---|---|---|---|
| | Units | 1 | 2 |
| Reaction | ° C. | 80 | 80 |
| Temp | | | |
| C₆/C₂ | mol/mol | 0.0088 | 0.0002 |
| H₂/C₂ | mol/mol | 0.0010 | 0.000644 |
| C₂ | psi | 130 | 130 |
| Partial | | | |
| Pressure | | | |
| Catalyst | cm³/hr | 15 | 11 |
| slurry feed | | | |
| rate | | | |
| Average | hr | 3.04 | 2.67 |
| residence | | | |
| time | | | |
| Average | lb | 129.7 | 138.7 |
| Bed weight | | | |
| Productivity | lb/lb | 10,192 | 7,109 |

TABLE 2

| | | Example | Example |
|---|---|---|---|
| | Unit | 1 | 2 |
| Density | g/cm³ | 0.935 | 0.954 |
| Melt Index | dg/min | 7.8 | 2.2 |
| (I₂) | | | |
| Melt Index | dg/min | 155.7 | 36.5 |
| (I₂₁) | | | |
| (I₂₁)/(I₂) | | 20.0 | 16.6 |
| Mn | g/mol | 23,222 | 33,802 |
| Mw | g/mol | 65,557 | 97,436 |
| Mz | g/mol | 150,847 | 226,233 |
| Mw/Mn | | 2.82 | 2.88 |
| MWCDl | | 3.57 | 0.41 |
| ESCR F50 | hr | | 18 |
| 10% Igepal | | | |
| (Condition A) | | | |
| ESCR F50 | hr | 456 | 25 |
| 10% Igepal | | | |
| (Condition B) | | | |
| −40° C. | J/m | 46 | 68 |
| Charpy | | | |
| impact | | | |
| strength | | | |
| Flexural | ksi | 129.6 | 208.6 |
| Modulus | | | |
| Secant | ksi | 109 | 183 |
| Modulus at | | | |
| 1% | | | |
| Secant | ksi | 93.4 | 154.0 |
| Modulus at | | | |
| 2% | | | |
| ZSV | Pa*s | 1180 | 3425 |
| Heat | ° C. | 62 | 78 |
| Distortion | | | |
| Temperature | | | |
| VICAT | ° C. | 117 | 129 |

TABLE 3

| | | Comp. | Comp. | Comp. | Comp. | Comp. | Comp. | Comp. | Comp. |
|---|---|---|---|---|---|---|---|---|---|
| | | Ex. | Ex. | Ex. | Ex. | Ex. | Ex. | Ex. | Ex. |
| | | A | B | C | D | E | F | G | H |
| Modality | | Unimodal | Unimodal | Unimodal | Unimodal | Unimodal | Unimodal | Bimodal | Bimodal |
| Density | g/cm³ | 0.935 | 0.935 | 0.935 | 0.935 | 0.941 | 0.943 | 0.946 | 0.946 |
| Melt Index (I2) | dg/min | 6.1 | 5.5 | 5.3 | 7.2 | 2.0 | 2.1 | 1.8 | 2.0 |
| Flow Index (I21) | dg/min | 150.4 | 127.2 | 115.5 | 126.9 | 47.4 | 50.7 | 61.7 | 50.5 |
| I21/I2 | | 20.8 | 24.9 | 21.6 | 17.6 | 24.0 | 24.8 | 35.0 | 25.0 |
| Mn | g/mol | 18,769 | 20,356 | 24,354 | 23359 | 27413 | 27,044 | 25,650 | 32,957 |
| Mw | g/mol | 74,176 | 80,657 | 65,339 | 66,082 | 105,866 | 108,741 | 98,291 | 94,286 |
| Mz | g/mol | 252,065 | 270,210 | 124,207 | 129,920 | 360787 | 366,159 | 280,824 | 225,038 |
| Mw/Mn | | 4.0 | 4.0 | 2.7 | 2.8 | 3.9 | 4.0 | 3.8 | 2.9 |
| MWCDI | | −3.28 | −2.89 | 0.28 | 1.07 | −1.16 | −3.13 | 0.29 | 1.76 |
| ESCR F50 | hr | 30 | 44 | 19 | 46 | 33 | 25 | 43 | 66 |
| 10% Igepal | | | | | | | | | |
| (Condition A) | | | | | | | | | |
| ESCR F50 | hr | 30 | 386 | 18 | — | 44 | 26 | 55 | 100 |
| 10% Igepal) | | | | | | | | | |
| (Condition B) | | | | | | | | | |
| Charpy Impact | J/m | 37 | 41.8 | 49 | 49 | 37 | 46 | 44 | 58 |
| Strength @ −40 C. | | | | | | | | | |
| Flexural Modulus | ksi | 94.0 | 100.9 | 117.5 | 110.9 | 124.4 | 157.0 | 156.5 | 150.7 |
| Secant Modulus | ksi | 75 | 77.2 | 97 | 94 | 99 | 128 | 132 | 122 |
| at 1% | | | | | | | | | |
| Secant Modulus | ksi | 64.4 | 66.1 | 82.4 | 80.9 | 83.6 | 112.7 | 111.8 | 102.1 |
| at 2% | | | | | | | | | |
| Zero-Shear | Pa*s | 1318 | 1806 | 1628 | 1087 | 4719 | 4541 | 5349 | 4397 |
| Viscosity (ZSV) | | | | | | | | | |
| Heat Distortion | ° C. | 51 | 53 | 52 | 53 | 60 | 61 | 63 | 64 |
| Temperature | | | | | | | | | |
| VICAT | ° C. | 112 | 114 | 117 | — | 122 | 119 | 124 | |

The data of Table 2 illustrate that polyolefin compositions Example 1 and Example 2, both made utilizing the spray-dried composition utilizing the asymmetrical hafnium metallocene having an n-propyl cyclopentadienyl ligand, represented by structure (II), had a molecular weight comonomer distribution index (MWCDI) greater than 0.

The data of Table 2 illustrate that polyolefin compositions Example 1 and Example 2 each had a density from 0.925 to 0.955 g/cm³.

The data of Table 2 illustrate that polyolefin compositions Example 1 and Example 2 each had an I₂ from 1.0 to 10.0 dg/min.

The data of Table 2 illustrate that polyolefin compositions Example 1 and Example 2 each had Mw/Mn from 2.0 to 3.5.

The data of Table 2 illustrate that polyolefin compositions Example 1 and Example 2 each had a −40° C. Charpy impact strength greater than 40 J/m.

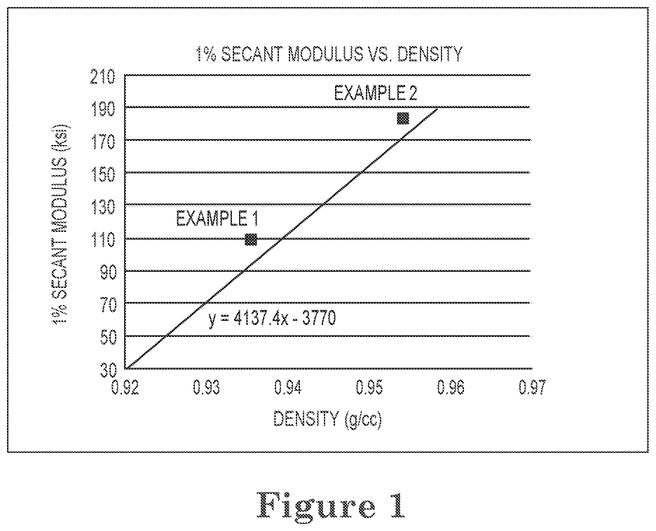

FIG. 1 is a data plot of secant modulus at 1% vs density according to an embodiment of the present disclosure. The data of FIG. 1 illustrate that polyolefin compositions Example 1 and Example 2 each had a Secant Modulus at 1% vs Density relationship such that: 1% secant modulus >4137.4*density-3770. This relationship is surprising and not seen with the Comparative Examples.

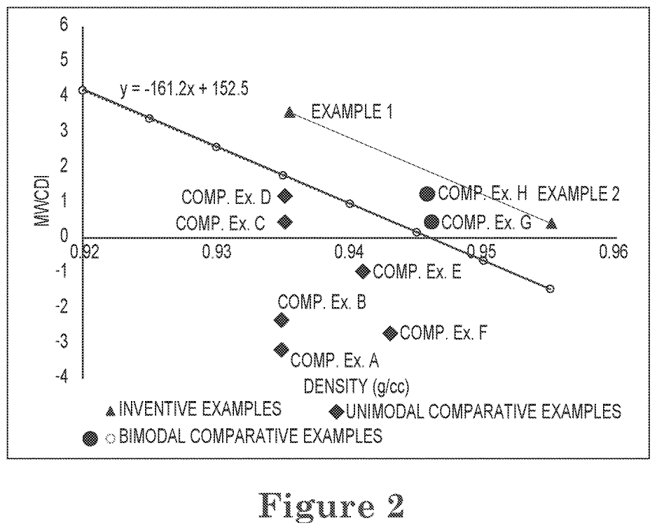

FIG. 2 is a data plot of molecular weight comonomer distribution index (MWCDI) vs density according to an embodiment of the present disclosure. The data of FIG. 2 illustrate that polyolefin compositions Example 1 and Example 2 each had a MWCDI vs Density relationship such that: MWCDI>−161.2*Density+152.5. This relationship is surprising and not seen with the unimodal Comparative Examples.

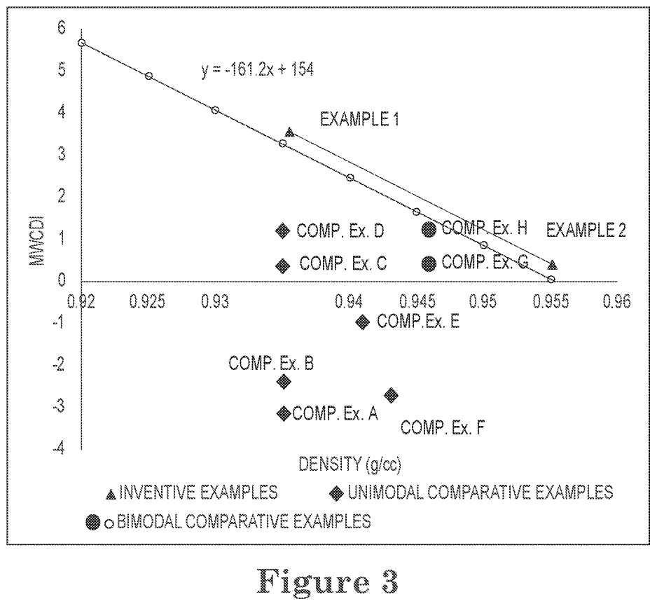

FIG. 3 is a data plot of molecular weight comonomer distribution index (MWCDI) vs density according to an embodiment of the present disclosure. The data of FIG. 2 illustrate that polyolefin compositions Example 1 and Example 2 each had a MWCDI vs Density relationship such that: MWCDI>−161.2*Density+154. This relationship is surprising and not seen with the unimodal Comparative Examples.

1. A polyolefin composition, wherein the polyolefin composition has:
a density from 0.925 to 0.960 g/cm³;
a melt index (I₂) from 1.0 to 10.0 dg/min;
a Mn of 17,000 to 40,000;
a Mw of 50,000 to 120,000;
a Mz of 120,000 to 300,000;
a molecular weight distribution (Mw/Mn) from 2.0 to 3.5; and
a molecular weight comonomer distribution index vs density relationship such that: molecular weight comonomer distribution index>−161.2*Density+152.5.

2. The polyolefin composition of claim 1, wherein the polyolefin composition has molecular weight comonomer distribution index vs density relationship such that: molecular weight comonomer distribution index>−161.2*Density+154.

3. The polyolefin composition of claim 1, wherein the polyolefin composition has a −40° C. Charpy impact strength greater than 40 J/m.

4. The polyolefin composition of claim 1, wherein the polyolefin composition has a secant modulus at 1% vs density relationship such that: 1% secant modulus >4137.4*density-3770.

5. The polyolefin composition of claim 1, when the density is from 0.925 to 0.939 g/cm³ the molecular weight comonomer distribution index is greater than 2.5, when the density is from 0.940 to 0.945 g/cm³ the molecular weight comonomer distribution index is greater than 1.5, when the density is from 0.946 to 0.950 g/cm³ the molecular weight comonomer distribution index is greater than 1.0, and when the density is from 0.951 to 0.960 g/cm³ the molecular weight comonomer distribution index is greater than 0.

6. The polyolefin composition of claim 1, wherein the polyolefin composition has an environmental stress cracking resistance (ESCR) F₅₀>20 hours (ASTM D-1693, Method B, 10% Igepal).

7. The polyolefin composition of claim 1, wherein the polyolefin composition is unimodal.

8. A rotomolding article made with the polyolefin composition of any claim 1.

9. A method for making the polyolefin composition of claim 1, the method comprising:
making a catalyst composition utilizing an asymmetrical hafnium metallocene; and
contacting the catalyst composition and ethylene and, optionally, a comonomer selected from the group consisting of propene and a (C₄-C₂₀) alpha-olefins to make the polyolefin composition.

10. A method for making the polyolefin composition of claim 1, the method comprising:
making a catalyst composition utilizing an asymmetrical hafnium metallocene; and
contacting the catalyst composition and ethylene and, optionally, a comonomer selected from the group consisting of propene and a (C₄-C₂₀) alpha-olefins to make the polyolefin composition.

11. The method of claim 9, wherein the asymmetrical hafnium metallocene has an n-propyl cyclopentadienyl ligand and the asymmetrical hafnium metallocene can represented by structure (I): 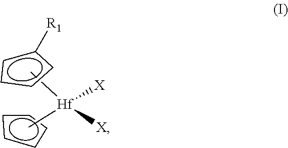
wherein R¹ n-propyl; and each X is independently a leaving group.
